(19) United States
(12) Patent Application Publication
(10) Pub. No.: US 2026/0166606 A1
(43) Pub. Date: Jun. 18, 2026

(54) HOT-MELTING DECHLORINATION PRETREATMENT DEVICE FOR WASTE PLASTICS

(71) Applicant: China University of Petroleum (East China), Qingdao (CN)

(72) Inventors: Yiliang TIAN, Qingdao (CN); Yingyun QIAO, Qingdao (CN); Yuanyu TIAN, Qingdao (CN); Peijie ZONG, Qingdao (CN); Jie LI, Qingdao (CN); Aowen HU, Qingdao (CN); Shuya LI, Qingdao (CN); Jingwu WEI, Qingdao (CN); Quan GAN, Qingdao (CN); Dan LUO, Qingdao (CN)

(21) Appl. No.: 19/421,896

(22) Filed: Dec. 16, 2025

(30) Foreign Application Priority Data
Dec. 17, 2024 (CN) 202411865194.1

(51) Int. Cl. B09B 3/70; B09B 3/40; B09B 101/77

(52) U.S. Cl. CPC B09B 3/70; B09B 3/40; B09B 2101/77

(57) ABSTRACT

The present disclosure relates to a hot-melting dechlorination pretreatment device for waste plastics, wherein a waste plastic pulverizer is connected with a water-cooling feeding pipe through a controllable feeder. A pyrolysis dry gas injection inlet is provided at the top of the feeding pipe, and the bottom connects with a hot-melt dechlorination reactor equipped with a stirrer. A high-temperature hot-melt oil inlet is disposed at the upper part of the reactor, and a pyrolysis dry gas stripping distributor is arranged at the lower part. One path of the bottom connects to a high-speed circulating pipe with heating and returns to the upper part through a delivery pump, and the other path is used as raw material of the pyrolysis liquefaction device. A fuel gas extraction opening at the top connects with a desulfurization dechlorination reactor; one path recycles gas, the other discharges pyrolysis dry gas outward.

### CROSS-REFERENCE TO RELATED APPLICATIONS

The application claims priority to Chinese Application No. 202411865194.1, filed on Dec. 17, 2024 and entitled “HOT-MELTING DECHLORINATION PRETREATMENT DEVICE FOR WASTE PLASTICS”, the content of which is specifically and entirely incorporated herein by reference.

### FIELD

The present disclosure provides a hot-melting dechlorination pretreatment device for waste plastics, which belongs to the field of environmental engineering.

### BACKGROUND

Although the widespread use of plastics has provided great convenience for daily life of the people, it has also brought forth a lot of white pollution. The use cycle of plastics is very short. A large number of plastic products, especially packaging materials, are discarded about 6-12 months after putting into use. 40% of plastics are discarded after 1-2 years. The total annual output of plastic waste in the world has reached 50 million tons. In the past few decades, waste plastics have been regarded as a part of municipal solid waste (MSW). According to surveys, waste plastics account for 4-10 wt % or 10-20 vol % of MSW in the industrially developed countries, mainly derived from packaging waste, automobile garbage and processing waste. The percentages of various types of waste plastics are as follows: 27% of low-density polyethylene (LDPE), 21% of high-density polyethylene (HDPE), 18% of polypropylene (PP), 16% of polystyrene (PS), and 7% of polyvinyl chloride (PVC). Due to the lack of efficient, clean and large-scale processing technology, the waste plastics have emerged as an environmental challenge that needs to be solved in the world.

The landfilling, incineration and recycling are the three main methods for the treatment of urban plastic solid wastes. Because of the different national conditions, the treatment methods of urban plastic solid wastes vary from country to country. The United States of America (USA) mainly utilizes the landfilling method, while Europe and Japan mainly adopt the incineration method. At present, the rapid pyrolysis/catalytic pyrolysis liquefaction or chemical production of waste plastics has attracted the focus of attention in China and foreign countries, and is also the waste plastic treatment technology with the most promising industrialization prospects.

The rapid pyrolysis/catalytic pyrolysis of waste plastics is an effective recycling means involving with heating and decomposing waste plastics at high temperatures under oxygen-free or low-oxygen conditions and producing valuable products, such as the pyrolysis and liquefaction of waste plastics to produce gasoline, diesel oil, petroleum wax and other chemical raw materials. However, in view of the characteristics of waste plastics such as large size and light weight, difficulty in compression, poor air permeability, easy expansion, prone to melting and bonding, and poor thermal conductivity, it is difficult to solve the problem of continuous feeding and rapid heating. At present, most of the pyrolysis and liquefaction of waste plastics adopt reaction kettle-type intermittent reactions and horizontal type rotary kiln reactions, with the defects of slow heating rate, severe feedstock adhesion and coking, low liquid product yield and added value, difficult to improve processing capacity, difficult to scale up the pyrolysis device, and the subsequent processing of chlorine-containing liquid products is challenging, the defects have hampered the efficient, clean and large-scale utilization of waste plastics. At present, there is no large-scale waste plastic pyrolysis device in commercial operation. It is urgent to develop the hot-melting dechlorination pretreatment device and equipment technology for waste plastics to lay the foundation for the clean and efficient pyrolysis of waste plastics to obtain the high-value products.

### SUMMARY

The present disclosure aims to overcome the defects of the existing waste plastic pyrolysis liquefaction technology, and provides a hot-melting dechlorination pretreatment device for waste plastics, wherein the device uses the waste plastic pyrolysis dry gas and high-temperature oil slurry circulation to carry out hot-melt dechlorination and desulfurization pretreatment, so as to solve the difficulties regarding the waste plastic pyrolysis feeding and removing the heteroatoms such as chlorine and sulfur through liquid atomization feeding, thereby improving the conversion efficiency, inhibiting the condensation polymerization and coke formation, and realizing the controllable cracking of waste plastics and efficient, clean, high-value and large-scale utilization.

The technical solution of the present disclosure is as follows:

The present disclosure provides a hot-melting dechlorination pretreatment device for waste plastics, wherein a waste plastic pulverizer is connected with a water-cooling feeding pipe through a controllable feeder, a pyrolysis dry gas injection inlet is provided at the top of the water-cooling feeding pipe, and the bottom of the water-cooling feeding pipe is connected with a hot-melt dechlorination reactor equipped with a stirrer; a high-temperature hot-melt oil inlet is disposed at the upper part of the hot-melt dechlorination reactor, a pyrolysis dry gas stripping distributor is arranged at the lower part of the hot-melt dechlorination reactor, one path of the bottom of the hot-melt dechlorination reactor is connected to a high-speed circulating pipe with a heating function and returns to the upper part of the hot-melt dechlorination reactor through a delivery pump, and the other path is used as a raw material of a pyrolysis liquefaction device; a fuel gas extraction opening at the top of the hot-melt dechlorination reactor is connected with a desulfurization dechlorination reactor, one path is used as recycle gas to return to the pyrolysis dry gas injection inlet and the pyrolysis dry gas stripping distributor, and the other path is used as pyrolysis dry gas to be discharged outwardly; a temperature of the water-cooling feeding pipe is within the range of 20-95° C., a temperature of the high-temperature hot-melt oil is within the range of 240-320° C., a temperature of molten plastic liquid after heating by the high-speed circulating pipe is 20-60° C. higher than the high-temperature hot-melt oil, a flow rate of the high-speed circulating pipe is within the range of 2-30 m/s, and a mass ratio of the molten plastic liquid which returns to the upper part of the hot-melt dechlorination reactor to raw material of the hot-melt dechlorination reactor is (1-10):1.

The outer wall of the water-cooling feeding pipe is provided with a water-cooling jacket, wherein the water-cooling feeding pipe has a positive conical shape, straight-pipe, or reverse conical shape, preferably a positive conical shape.

The controllable feeder is a rotary feeder, a dual-axis screw feeder or a single-axis screw feeder.

The heating of the high-speed circulating pipe is performed by electromagnetic induction heating, heat conductive oil heating, steam heating or resistive heating, preferably electromagnetic induction heating.

The characteristics of the present disclosure will be described in detail below with reference to examples.

### BRIEF DESCRIPTION OF THE DRAWINGS

FIG. 1 illustrates a schematic process flow diagram of the hot-melting dechlorination pretreatment device for waste plastics according to the present disclosure.

### DESCRIPTION OF REFERENCE SIGNS

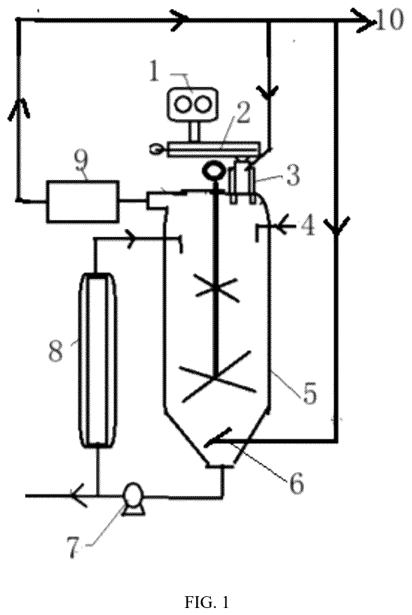

The reference signs in FIG. 1 are as follows:
1. Waste plastic pulverizer
2. Controllable feeder
3. Water-cooling feeding pipe
4. High-temperature hot-melt oil inlet
5. Hot-melt dechlorination reactor
6. Pyrolysis dry gas stripping distributor
7. Delivery pump
8. High-speed circulating pipe
9. Desulfurization dechlorination reactor
10. Pyrolysis dry gas outlet

The technological characteristics of the present disclosure are described in detail below with reference to the attached drawings and examples.

### DETAILED DESCRIPTION

The present disclosure provided a hot-melting dechlorination pretreatment device for waste plastics, wherein a waste plastic pulverizer (1) was connected with a water-cooling feeding pipe (3) through a controllable feeder (2), a pyrolysis dry gas injection inlet was provided at the top of the water-cooling feeding pipe (3), and the bottom of the water-cooling feeding pipe was connected with a hot-melt dechlorination reactor (5) equipped with a stirrer; a high-temperature hot-melt oil inlet (4) was disposed at the upper part of the hot-melt dechlorination reactor (5), a pyrolysis dry gas stripping distributor (6) was arranged at the lower part of the hot-melt dechlorination reactor, one path of the bottom of the hot-melt dechlorination reactor was connected to a high-speed circulating pipe (8) with a heating function and returned to the upper part of the hot-melt dechlorination reactor (5) through a delivery pump (7), and the other path was used as a raw material of a pyrolysis liquefaction device for outgoing delivery; a fuel gas extraction opening at the top of the hot-melt dechlorination reactor (5) was connected with a desulfurization dechlorination reactor (9), one path was used as recycle gas to return to the pyrolysis dry gas injection inlet and the pyrolysis dry gas stripping distributor (6), and the other path was used as pyrolysis dry gas to be discharged outwardly from the pyrolysis dry gas outlet (10); a temperature of the water-cooling feeding pipe (3) was within the range of 20-95° C., a temperature of high-temperature hot-melt oil was within the range of 240-320° C., a temperature of molten plastic liquid after heating by the high-speed circulating pipe (8) was 20-60° C. higher than the high-temperature hot-melt oil, a flow rate of the high-speed circulating pipe (8) was within the range of 2-30 m/s, and a mass ratio of the molten plastic liquid which returns to the upper part of the hot-melt dechlorination reactor to raw material of the hot-melt dechlorination reactor is (1-10):1.

The outer wall of the water-cooling feeding pipe (3) was provided with a water-cooling jacket, wherein the water-cooling feeding pipe has a positive conical shape, straight-pipe, or reverse conical shape, preferably a positive conical shape.

The controllable feeder (2) was a rotary feeder, a dual-axis screw feeder or a single-axis screw feeder.

The heating of the high-speed circulating pipe (8) was performed by electromagnetic induction heating, heat conductive oil heating, steam heating or resistive heating, preferably electromagnetic induction heating.

In specific operation, the clean PE and PP waste plastics were sorted and pass through a waste plastic pulverizer (1), the waste plastic fragments were added into a water-cooling feeding pipe (3) with a temperature of 20-95° C. through a controllable feeder (2), and falled into a 240-320° C. high-temperature hot-melt oil in a hot-melt dechlorination reactor (5) with a stirrer under the carrying of pyrolysis dry gas, and subjected to the melt dechlorination and desulfurization pretreatment through stirring, mixing and pyrolysis dry gas stripping; the molten plastic liquid extracted from the bottom of the hot-melt dechlorination reactor (5) was pressurized and conveyed through a conveying pump (7), a part of the molten plastic liquid was heated by a high-speed circulation pipe (8) quipped with an external heater to a temperature 20-60° C. higher than that of the high-temperature hot-melt oil and then returned to the upper part of the hot-melt dechlorination reactor (5), another part of the molten plastic liquid was used as raw material of the pyrolysis liquefaction device for outgoing delivery; the pyrolysis dry gas extracted from the top of the hot-melt dechlorination reactor (5) was treated by the desulfurization dechlorination reactor (9), one path was used as recycle gas to return to the pyrolysis dry gas injection inlet and the pyrolysis dry gas stripping distributor (6), and the other path was used as pyrolysis dry gas to be discharged outwardly from the pyrolysis dry gas outlet (10); a temperature of the molten plastic liquid after heating by the high-speed circulating pipe (8) was 20-60° C. higher than the high-temperature hot-melt oil, a flow rate of the high-speed circulating pipe (8) was within the range of 2-30 m/s, and a mass ratio of the molten plastic liquid which returns to the upper part of the hot-melt dechlorination reactor to raw material of the hot-melt dechlorination reactor is (1-10):1. Finally, the waste plastics that were easily softened and melted by heat and difficult to feed may be turned into that liquid feedstock that can be easily transported by pumping.

The hot-melting dechlorination pretreatment device for waste plastics can convert waste plastics that were easily softened and melted by heat and difficult to feed in the solid phase into the liquid phase molten plastic liquid that can be easily transported by pumping, and can realize continuous, large-scale, efficient, clean and high-value pyrolysis utilization of waste plastics, and solved the five common industry challenges such as waste plastic feedstock adhesion and coking, difficulty in mixing with high-temperature catalysts, low liquid product yield and added value, difficulty in scaling up the pyrolysis device, and difficulty in subsequent processing of liquid products containing chlorine. The total yield of liquid products used for pyrolysis was more than 95%, which was more than 25 percentage points higher than that of traditional waste plastic pyrolysis technology, ensured the stable, long-term and optimal operation of the device.

1. A hot-melting dechlorination pretreatment device for waste plastics, wherein a waste plastic pulverizer is connected with a water-cooling feeding pipe through a controllable feeder, a pyrolysis dry gas injection inlet is provided at the top of the water-cooling feeding pipe, and the bottom of the water-cooling feeding pipe is connected with a hot-melt dechlorination reactor equipped with a stirrer; a high-temperature hot-melt oil inlet is disposed at the upper part of the hot-melt dechlorination reactor, a pyrolysis dry gas stripping distributor is arranged at the lower part of the hot-melt dechlorination reactor, one path of the bottom of the hot-melt dechlorination reactor is connected to a high-speed circulating pipe with a heating function and returns to the upper part of the hot-melt dechlorination reactor through a delivery pump, and the other path is used as a raw material of a pyrolysis liquefaction device; a fuel gas extraction opening at the top of the hot-melt dechlorination reactor is connected with a desulfurization dechlorination reactor, one path is used as recycle gas to return to the pyrolysis dry gas injection inlet and the pyrolysis dry gas stripping distributor, and the other path is used as pyrolysis dry gas to be discharged outwardly; a temperature of the water-cooling feeding pipe is within the range of 20-95° C., a temperature of high-temperature hot-melt oil is within the range of 240-320° C., a temperature of molten plastic liquid after heating by the high-speed circulating pipe is 20-60° C. higher than the high-temperature hot-melt oil, a flow rate of the high-speed circulating pipe is within the range of 2-30 m/s, and a mass ratio of the molten plastic liquid which returns to the upper part of the hot-melt dechlorination reactor to raw material of the hot-melt dechlorination reactor is (1-10):1.

2. The hot-melting dechlorination pretreatment device for waste plastics according to claim 1, wherein the outer wall of the water-cooling feeding pipe is provided with a water-cooling jacket, wherein the water-cooling feeding pipe has a positive conical shape, straight-pipe, or reverse conical shape.

3. The hot-melting dechlorination pretreatment device for waste plastics according to claim 1, wherein the water-cooling feeding pipe has a positive conical shape.

4. The hot-melting dechlorination pretreatment device for waste plastics according to claim 1, wherein the controllable feeder is a rotary feeder.

5. The hot-melting dechlorination pretreatment device for waste plastics according to claim 1, wherein the controllable feeder is a dual-axis screw feeder or a single-axis screw feeder.

6. The hot-melting dechlorination pretreatment device for waste plastics according to claim 1, wherein the heating of the high-speed circulating pipe is performed by electromagnetic induction heating, heat conductive oil heating, steam heating or resistive heating.

7. The hot-melting dechlorination pretreatment device for waste plastics according to claim 1, wherein the heating of the high-speed circulating pipe is performed by electromagnetic induction heating.
